(19) United States
(12) Patent Application Publication
(10) Pub. No.: US 2004/0049533 A1
(43) Pub. Date: Mar. 11, 2004

(54) Interactive screensaver

(76) Inventor: Leonard K. Knight, San Diego, CA (US)

Correspondence Address: FISH & RICHARDSON, PC, 12390 EL CAMINO REAL, SAN DIEGO, CA, 92130-2081, US

(21) Appl. No.: 10/236,695

(22) Filed: Sep. 6, 2002

(51) Int. Cl. G06F 15/16; G09G 5/00

(52) U.S. Cl. 709/203; 345/867

(57) ABSTRACT

A system for displaying data on a screensaver window, the system including a user device, the user device including a processor for executing a screensaver process, a visual display for displaying the screensaver window, and an input device coupled to the user device for interacting with the screensaver window, wherein the user device executes the screensaver process and causes the display of the screensaver window on the visual display, the screensaver window having an active region selectable by a user and a first mobile image, and wherein a selection of the active region causes an additional image to be displayed over the screensaver window.

### TECHNICAL FIELD

This application relates to display of information on an interactive screensaver display.

### BACKGROUND

A user may interact with a network device, e.g., a personal computer or wireless device that transmits (sending and receiving, e.g.) messages from a computer network and includes a visual display device for displaying text and images. The network appliance (“user device”) typically will include a graphical user interface (GUI) to allow a user to interact with an operating system running on the user device. Many GUI's include a windows environment and a desktop. The windows environment presents the user with specially delineated areas called windows on the display device, each of which is dedicated to a particular application program, file or document. Typically, the windows may be re-sized, moved around on the display, and stacked to overlay other windows. The windowing environment allows windows to be increased to a full-screen display or minimized, meaning the window is reduced to and denoted by an icon.

The desktop in many GUIs refers to a desktop metaphor, where the desktop is a graphical work surface analogous to a surface of a desk. Similarly, windows overlay the desktop in the graphical user interface analogous to papers or files laying on top of the desk. Typically the desktop displays icons representing programs, files and resources available to the user. As such, the desktop acts as a launching point for running application programs, opening documents or files, displaying menus, and initiating operating system services.

The display device on the user device may be damaged if left on for an extended period of time while constantly displaying an immobile image (i.e., “burning in” an image on the display device screen). To avoid this type of damage a screensaver application may be used to display a time-varying pattern on a screensaver window. Typically, the screensaver window covers the entire visual display area and covers the desktop display whenever the user device has been inactive for a pre-determined period of time. The screensaver window is cleared from the desktop display whenever any input activity is detected, e.g., a key depression on a keyboard or movement of a mouse.

A user a network device may access “on-line” resources by connecting to a network of computers, e.g., the Internet. The Internet is a worldwide collection of cooperating computer networks. A user typically accesses the Internet by establishing a connection from the user device to a server computer through a communications medium, e.g., a phone line, cable line or wireless connection. The server computer may then download electronic documents that contain data and/or executable objects. The electronic documents transferred between a user device and the server computer are sometimes referred to as “content” or “media”, which refers to the various types of information that may be represented by the data, for example, textual information, graphical information, animation and/or video information, voice information, etc.

The user device and server computer communicate through software protocols, such as File Transfer Protocol (FTP), Simple Mail Transfer Protocol (SMTP), Hypertext Transfer Protocol (HTTP), etc. HTTP is a widely used protocol and is used for accessing the World Wide Web. The World Wide Web is a portion of the Internet consisting of many server computers, also referred to as “sites,” which make media documents in HTML format available for downloading or retrieval by individuals having a computer with Internet access. The documents are generally created in Hypertext Markup Language (HTML) and displayed on a user device. HTML documents may include embedded hyperlinks that reference other locations (e.g., a folder, a FTP site, other HTML documents, etc.). The user device may retrieve and display documents associated with the other location when the user activates an embedded hyperlink.

### DESCRIPTION OF THE DRAWINGS

FIG. 1 is a block diagram of a system for displaying information on an interactive screensaver display.

FIG. 2 is a flowchart of a screensaver process.

FIG. 3 is a flowchart of a host process.

FIG. 4 is a block diagram of computer hardware on which the process of FIG. 2 and FIG. 3 may be implemented.

### DESCRIPTION

As used herein, the term “computer system” refers to a physical machine having one or more processing elements and one or more storage elements in communication with the one or more of the processing elements. Each of the various user devices and computers described herein include an operating system. The operating system is software that controls the computer system's operation and the allocation of resources. The term “process” or “program” refers to software, for example an application program that may be executed on a computer system. The application program is the set of executable instructions that performs a task desired by the user, using computer resources made available through the operating system.

The description contained herein presents an embodiment in which information is passed between a user and a user device, e.g., a computer system, using conventional means such as a keyboard, a mouse, a physical transducer (e.g., a microphone), etc. However, this is not meant to preclude the use of other mechanisms for passage of information between a user and a computer system.

Certain terms used throughout this specification and claims, although originating in the context of conventional visual displays, are intended to include corresponding functions in the context of other types of information delivery. For example, “Window” refers to any set of information available for presentation to a user. A “window” can include information displayed in a portion of a visual computer display. However, a window can also encompass the entire visual computer display.

A typical display window includes one or more “active” regions. The active regions are associated with instructions to be executed upon the occurrence of an event within an active region. For example, instructions associated with an active region may cause a jump to a specified location upon the occurrence of a mouse-click within the active region. Other events can also cause the execution of instructions. In particular, a detected movement of a mouse and/or an entry of a mouse pointer into an active region (in either case, with or without a click of a mouse button) are also events that may be used to trigger the execution of instructions associated with that region.

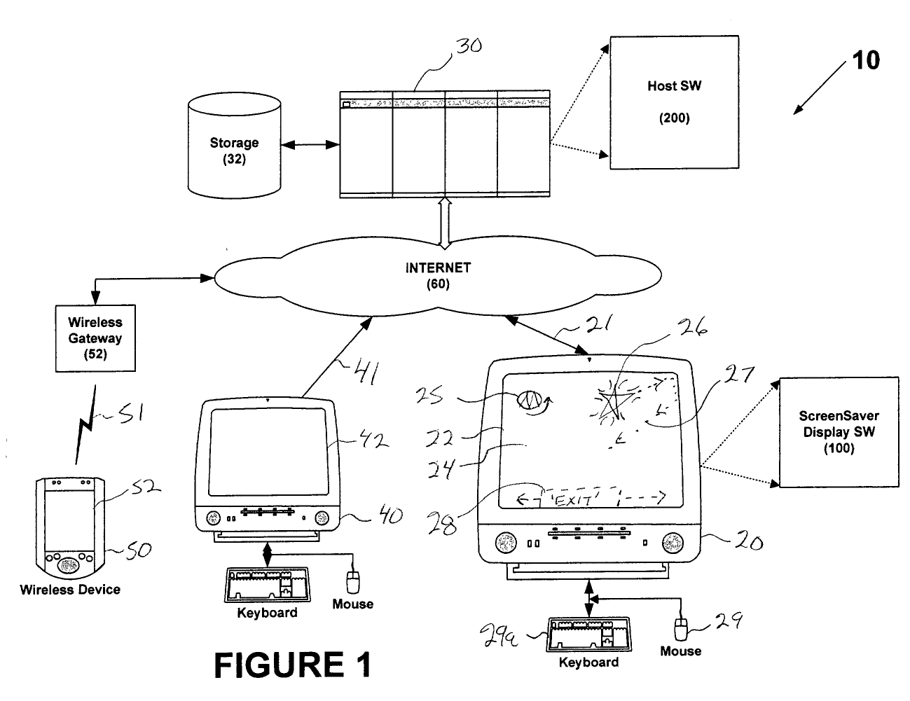

Referring to FIG. 1, a data communication system 10 includes a screensaver display process 100 that is performed on a user device 20 and a host process 200 that is performed on a host computer 30. User device 20 and host computer 30 are both coupled to a network of computers, such as Internet 60, and communicate with each other by sending messages and data through Internet 60. Screensaver process 100 causes the display of an “interactive” screensaver window 24 on a display device 22 of user device 20. Interactive screensaver window refers to a screensaver window having at least one active region that a user may select (or input information to). Unlike a conventional screensaver, interacting with interactive screensaver window 24 does not clear screensaver window 24, instead an active region (or an additional window having an active region) may be displayed on screensaver window 24, which, when selected by a user does not cause screensaver window 24 to be cleared. Screensaver window 24 includes a mobile image 26 that moves continuously along a random pathway 27 on the screensaver window. Screensaver window 24 also includes an active region 25 that a user may select (for example, by using a mouse 29 and/or a keyboard 29a). Selecting active region 25 causes the display of a menu of options over the screensaver window. The user may interact with the menu, e.g., making a selection and/or inputting information that is usable by screensaver process 100 and host process 200 to affect the display of the screensaver window and/or display additional “associated” windows. In more detail, upon selection of a menu item an associated window may be displayed over the screensaver window, however, the screensaver window remains on the display device covering the active desktop. The associated window may display text, graphic images and/or video images. Each associated window may also include associated audio outputs. Typically an associated window also includes one or more active regions that the user may interact with to affect the display of information on the associated window or to exit the associated window. The menu options may also allow a user to select an alternate mobile image 26 and/or an alternate active region image 25.

Screensaver process 100 includes instructions that, when executed, control the display of screensaver window 24 and associated windows that are displayed over screensaver window 24. The content of screensaver window 24 and the associated windows is based upon data files (“modules”) that are stored locally (on user device 20) or are stored on host computer 30. The modules include data and/or instructions that are used to define the content of the displayed mobile image, active region image, exit option image, menus, and the associated windows, for example. Therefore, images, menus and associated windows displayed by screensaver process 100 may be changed by downloading new modules (or module pathway information) to the user device from the host computer that are subsequently used by screensaver process 100 to update those images, menus and windows. In one embodiment, instead of downloading a new module to user device 20, host process 200 sends module pathway information to process 200, the file pathway information usable by process 20 to retrieve a module located on a computer on network 60.

The various images, menus and associated windows displayed by screensaver process 100 may be changed by host process 200. In more detail, host process 200 may send a data module (or module pathway information) to user device 20 that will be displayed as the mobile image on the screensaver display. This allows a user of host program 200 to cause the display of a new mobile image on the user's display device (e.g., a company logo, an advertising image, a text announcement, etc.) Host process 200 may also send other data modules to change other display areas controlled by screensaver process 100, for example, data modules to change available menu options, associated windows, active region 25, etc.

As the popularity of the Internet and the World Wide Web has increased businesses are trying to find ways of promoting their products in a cost-effective manner. Thus, there has been a tremendous proliferation of corporate advertising on the Internet. However, it is difficult to effectively target advertisements to those consumers most likely to use the product or service being offered. Therefore, a tremendous amount of advertising is wasted on promoting goods or services to an improper audience. As the number of people accessing the Internet increases, it will become more important to specifically target advertising to those individuals most likely to purchase the goods or services being offered. It will also be important for advertisers to know how effective a particular ad has become by tracking the responses of individual consumers.

In an embodiment, system 10 allows a user of host process 200 to download modules that include targeted advertisements and/or other information useful to the user (“consumer”) or user device 20. In one embodiment, tracking information is determined by screensaver process 100, e.g., storing data that reflects, for example, a user's interactions with screensaver process 100, a user's inputs to an associated window, a number of activations of screensaver window 24, etc. The tracking information is then usable by either process 100 and/or process 200 to determine the images, advertisements and associated windows that are most useful to that user. In this way, a user of system 10 may effectively target advertisements and other information to an interested user.

This example of system 10 includes multiple user devices, such as user devices 20, 40 and 50, which may be personal computers (PCs), wireless devices and similar devices that include a visual display device 22, 42 and 52, respectively. Each user device 20, 40 and 50, and host computer 30, is able to communicate with each other through network 60. For example, communicating through a modem (not shown) or through a wireless gateway device 52. Host process 200 may communicate and interact with multiple user devices, each of the user devices performing screensaver process 100. Host computer typically includes a storage device 32, for storing data and executable applications. In an embodiment, host process 200 stores screensaver tracking information in a database on storage device 32. Each entry in the database corresponding to a specific user device and/or a specific user. The data entries may be used by host process 200 to determine the preferences and past activity of each user device and user, and therefore be used to determine appropriate data modules for downloading to each user device.

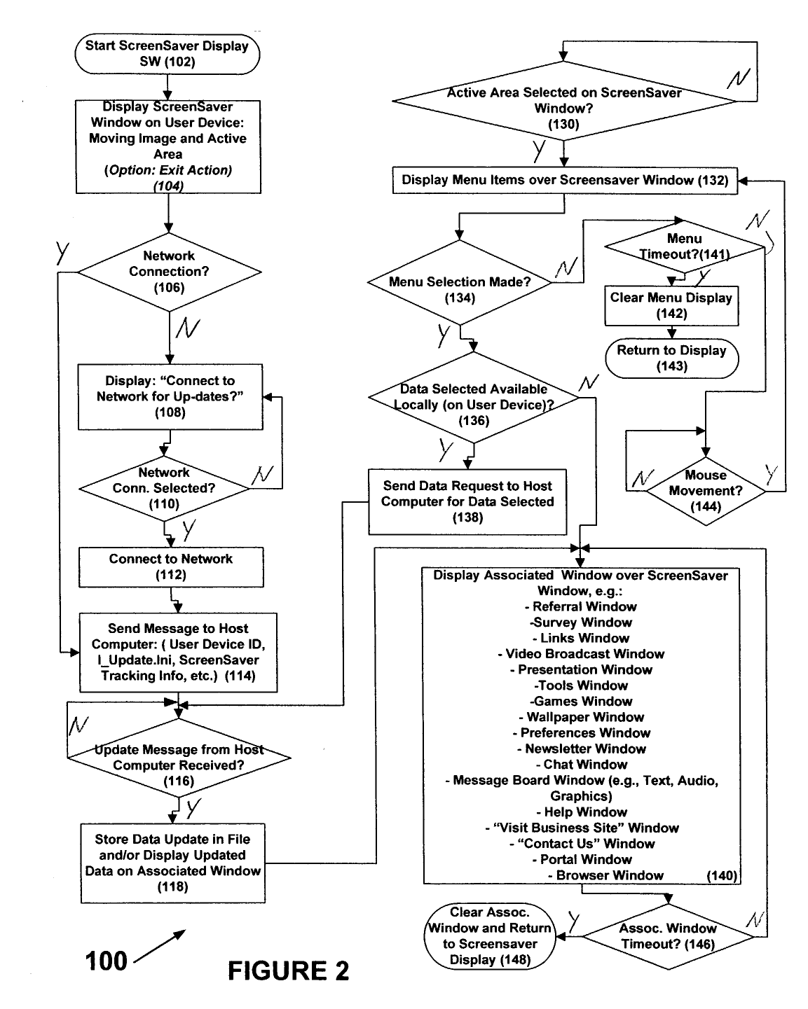

Referring to FIG. 2, an embodiment of performing screensaver process 100 is shown. Process 100 begins (102) and includes displaying (104) a screensaver window that includes a moving image and an active region, determining (106) whether a network connection is available. If the network connection is available, sending (114) a message to a host computer on the network. If the network connection is not available, displaying (108) a “Connect to Network for Updates?” option on the screen, and determining (110) whether the network connection menu option has been selected. If the network connection menu option is determined to be selected, connecting (112) to a computer network and sending (114) a message to the host computer. Process 100 includes determining (116) whether a message (or module) has been received from the host computer, and if a message has been received, storing (114) and/or displaying (118) the updated module as an associated window on the screensaver window. Once the screensaver display window is displayed on the user device, process 100 includes determining (130) whether an active region on screensaver has been selected. If an active region has been selected, displaying (132) menu options, determining (134) a menu selection has been made, determining (136) whether a data module corresponding to the menu selection is available locally and sending (138) a data request to the host computer if the data is not available locally. Once the data module selected is available, process 100 includes displaying (140) the data module on an associated window over the screensaver window. If it is determined (134) that no menu selection has been made, process 100 includes determining (141) whether a menu timeout period has expired and clearing (142) the menu options from the screensaver window and returning (143) to displaying (104) the screensaver window. If it is determined (142) that the menu has timed out, process 100 includes determining (144) whether mouse activity is detected, and if it has, displaying (132) menu options on the screensaver window. Each time an associated window is displayed (140), an “associated timer” is started corresponding to the amount of time since the associated window was activated. Process 100 includes determining (146) whether the associated window has been inactive longer than the associated timer period, and if has been inactive, clearing (148) the associated window and returning (148) to display the screensaver window (104).

Displaying (104) may optionally include displaying an exit option image that is moved on the screensaver display window. Alternatively, the exit option image may be an active region that when selected, by a mouse click, e.g., causing screensaver window 24 to be cleared.

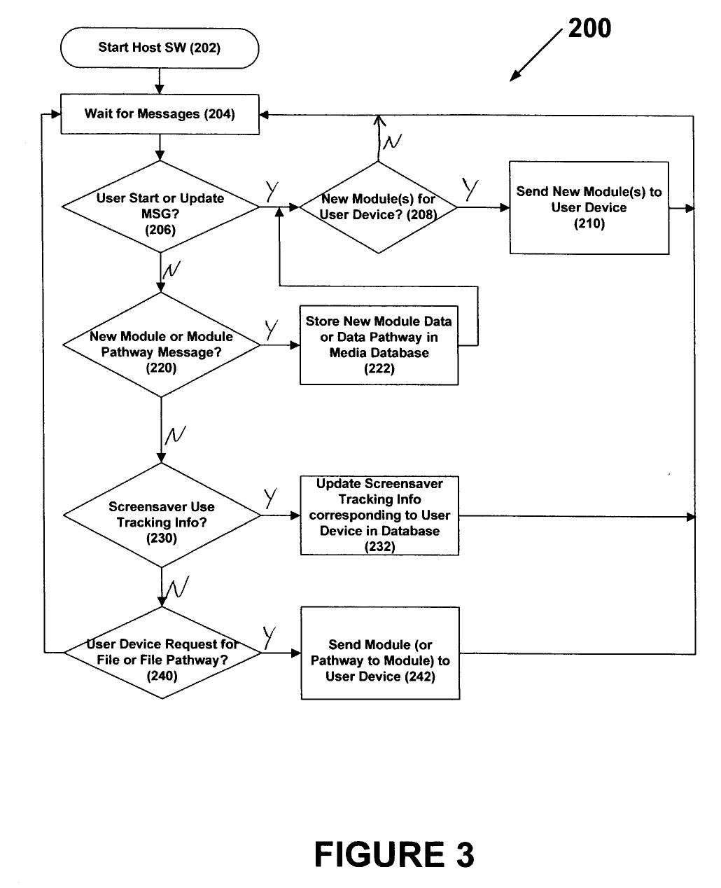

Referring to FIG. 3, an embodiment of performing host process 200 is shown. Process 200 begins (202) and includes waiting (204) for messages from a user device. When a message is received, process 200 includes determining (206) whether the received message is a user start or update message, and if it is a user start or update message, determining (208) whether new data modules are available for the user device and sending (210) those data modules to the user device. If it is determined (206) that the received message is not a user start or update message, determining (220) whether the received message is a new data module and if it is a new data module storing (222) the new data module in a database. If it is determined (220) that the received message is not a new module, determining (230) whether the message includes user device and/or user tracking information, and if it is determined to include user device and/or tracking information, updating (232) tracking information in a database. If it is determined (230) that the received message does not include user device and/or user tracking information, determining (240) whether the received message is a user device data module request, and if it is, sending (242) an appropriate data module to the user device, otherwise, returning (244) to waiting (204) for messages and/or data.

In one embodiment, screensaver process 100 displays screensaver window 24 whenever user device 20 has been inactive for a pre-determined period of time. In another embodiment, screensaver process 100 may be activated by a user action.

Still referring to FIG. 1, process 100 and/or process 200 includes determining whether a module stored on the user's device is ‘stale’, i.e., determining whether a new module needs to be downloaded from host computer 30 to user device 20. By downloading modules only when updated modules are required (or available), system 10 may reduce the number of files downloaded to user device 20, and may also reduce the response time of screensaver process 100 since it does not need to wait for module downloads modules that are up-to-date.

In an embodiment of screensaver process 100, the menu display is activated by selection of active region 25, for example by placing mouse 29 over active region 25 and clicking a mouse button. The menu display may also be activated upon detection of movement of mouse 29 whenever the menu display was previously activated within a specified time period.

In an embodiment, screensaver process 100 stores data on the user device to track the creation time and date of data modules that have been downloaded from host computer 30. Screensaver process 100 includes determining whether user device 20 is ‘on-line’, i.e., connected to network 60, and if it is connected, the date of the data modules stored locally are compared with the date of data modules on the host computer. In this example, a file called I_Update.Ini is used to hold the data module tracking information.

During the on-line connection to network 60, user device 20 may also send a data module pathway message to host computer 30. For example, the pathway message may include a file, folder or directory designation corresponding to a storage area on the user device. Host computer 30 may then use the pathway indicated by the message to direct data modules being downloaded to user device 20.

During the on-line connection to network 60, user device 20 may also determine user interaction data that relates to, for example, a user's interactions with screensaver process 100, an amount of time the screensaver window 24 has been displayed, the amount of time the mobile image has been displayed, a number of times a user has selected an active region on screensaver window 24, etc. The user interaction data may be sent to host computer 30 for use by host process 200.

In an embodiment, host process 200 stores data on the host computer 30 that is related to interactions of the user device with the host process 200, and/or interactions of a user with screensaver process 100, etc. For example, a file (in this case called “HOST.INI”) may be used to track the number of times a data request message is received by host process 200 from a particular user device, which data modules (or web-pages) were requested and/or accessed by that user device, a number of times a user has selected an active region on screensaver window 24, an amount of time screensaver window 24 has been displayed on a user device, a time stamp to indicate the last download of a data module from the host computer 30 to user device 20, etc. Data contained in HOST.INI may be used to analyze the use of the screensaver process 100 by a user. This interaction information may be advantageously used by host process 200, e.g., to determine how often and under what conditions the screensaver process 100 is being used, to determine how often and/or how long an advertising logo is displayed on screensaver window 24, to determine which available menu options have been selected by a user of screensaver process 100, etc. The interaction information may also be used to determine those modules that are likely to be most useful to a user of screensaver process 200.

Active region image 25 is typically not a mobile image, that is, it is displayed in a specific position on the screensaver window 24. However, active region image 25 may be displayed as a rotating image so that the screensaver window 24 will not cause damage to display device 22 by continually displaying an immobile image. In an alternate embodiment, the active region 25 is a mobile image that is moved on screensaver window 24.

Screensaver process 100 may include a specific action, or set of actions, that a user must perform to clear screensaver window 24. As an example, screensaver window 24 may be cleared by depressing a specific key, or any key, on keyboard 29a. In one embodiment, and as shown on FIG. 1, an optional ‘exit option’ image 28 may be displayed on the screensaver display program so that a user is informed of the specific action(s) required to clear the screensaver display window. In this example, exit option image 28 is a mobile image that alternately moves right and left across the bottom of screensaver window 24.

Screensaver process 100 may include a sub-process that is activated periodically even when screensaver window 24 is not being displayed. In this case the sub-process may send messages to and receive messages from host process 200. The received messages may include updated data modules that may be subsequently displayed when screensaver window 24 is displayed.

In one embodiment, screensaver process 100 includes the creation of a “cookie” stored on user device 20. The cookie may include a variety of information, for example, an identifier corresponding to user device 20, data corresponding to screensaver preferences made by a user, and the user interaction data (described previously), etc. The cookie may also include an identifier to identify different users of screensaver process 100, a serial number of the screensaver process 100, and/or an identifier for the user device. In this case, whenever a user device is on-line, the cookie may be retrieved by host process 200 and used to determine modules in which a particular user may be interested.

Still referring to FIGS. 1 and 2, displaying (140) an associated window may include displaying one or more of the following windows over screensaver window 24:

A ‘Wallpaper’ window that allows a user to select among images that will be displayed as the mobile image, for example, selecting among logos or advertisement images.

A ‘Preferences’ window that allows a user of screensaver program to select a display configuration(s) of the screensaver window and/or associated window(s). For example, the preferences window may allow a user to select audio, text and graphic features displayed via the screensaver window and/or associated windows. The preferences window may also allow a user to select the size of an image, size of an associated window, and/or the order of associated windows included on the screensaver window. The preferences window may also allow a user to select an “automatic” display of an associated window whenever the screensaver window is activated, e.g., an associated window is displayed each time the screensaver is activated without requiring an action by the user.

A ‘Presentations’ window that allows a user to select, for example, animated text, video presentations, images, etc., that are displayed on an associated window. The presentations menu may be useful to a business user of system 10, e.g., allowing a business user to cause the download of various presentations file that may include advertisements or promotional image(s) that a user may display over the screensaver window.

A ‘Games’ window that allows a user to select and play a game on an associated window.

A ‘Referral’ window that allows a user to refer other potential users of screensaver process 100. Referring other potential users may allow a user to earn points and/or awards from a business user of process 200, for example.

A ‘Survey’ window that allows a user to respond to survey questions, the responses usable by process 100 and process 200 to determine the user's interest in products, images, games, etc.

A ‘Links’ window that allows a user to select a link to a web-page, or enter a web-page address, and cause a jump to the selected, or entered, web-page.

A ‘Video Broadcast’ window that allows a user to select and display video images.

A ‘Presentation’ window that allows a user to select a presentation related to screensaver process 100, a business, A business product and/or promotion, for example.

A ‘Newsletter’ window that allows a user to read text and view images in a newsletter format. The information contained in the newsletter may be customized to relate to previously entered user preferences, and may also relate to a business product and/or promotion.

A ‘Chat’ window that allows a user to chat with other user's that are coupled to communicate on network 60.

A ‘Visit Business Site’ window that allows a user to select the display of web-site related to a business.

A ‘Contact Us’ window that allows a user to send a message to a user of host process 200 and/or a business user of host process 200.

A ‘Browser’ window that allows a user to display an associated window that is executing a browser program. In an embodiment, selecting the browser window causes the display of a web-site of a business user of process 200. In another embodiment, selecting a browser window causes the screensaver window 24 to be cleared, or minimized, until the browser window is closed.

A ‘Message Board’ window that allows a user to view a posted message from other users of process 200, a message posted by a business user, etc.

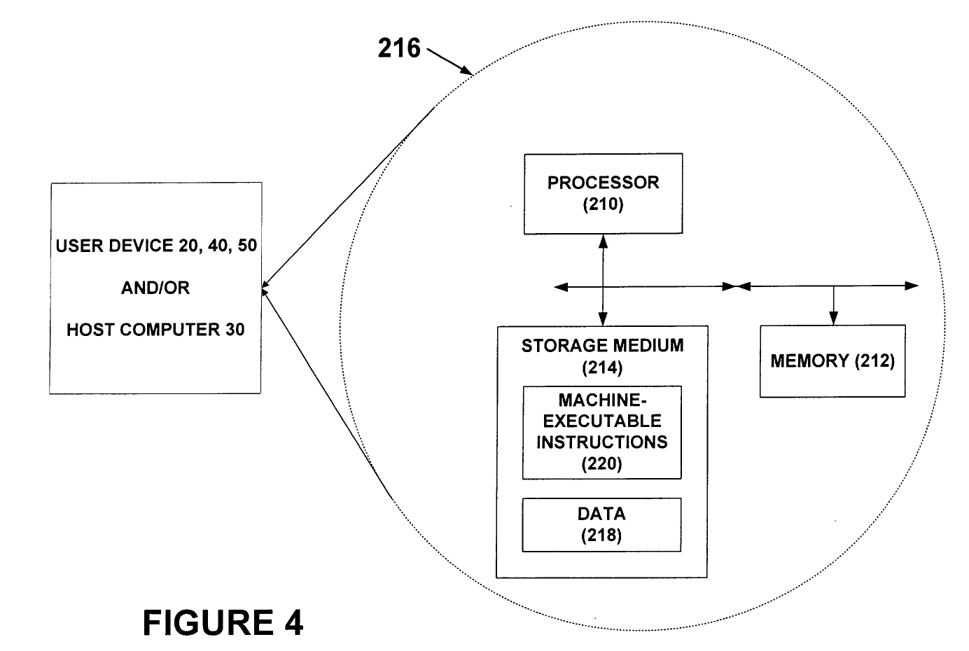

Referring to FIG. 4, in an embodiment of system 10, user devices 20, 40 and 50, and/or host computer 30 may include a processor 210, a memory 212, and a storage medium 214 (see view 216). Storage medium 214 stores data 218 for description documents and also stores machine-executable instructions 220 that are executed by processor 210 out of memory 212 to perform user device functions (for example, process 100), and/or host computer functions (for example, host process 200). Furthermore, each user device and host computer may include an operating system.

User devices and/or host computer are not limited to use with the hardware and software of FIG. 4. It may find applicability in any computing or processing environment. They may be implemented in hardware, software, or a combination of the two. They may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform applications and to generate output information.

Each computer program may be stored on a storage medium/article (e.g., CD-ROM, hard disk, or magnetic diskette) that is readable by a general or special purpose programmable computer for configuring and operating the computer when the storage medium or device is read by the computer to perform applications. They may also be implemented as a machine-readable storage medium, configured with a computer program, where, upon execution, instructions in the computer program cause a machine to operate in accordance with those applications.

The invention is not limited to the specific embodiments described above.

Other embodiments not described herein are also within the scope of the following claims.

What is claimed is:

1. A system for displaying data on a screensaver window, the system comprising:
a user device, the user device further comprising:
a processor for executing a screensaver process;
a visual display for displaying the screensaver window; and
an input device coupled to the user device for interacting with the screensaver window,
wherein the user device executes the screensaver process and causes the display of the screensaver window on the visual display, the screensaver window having an active region selectable by a user and a first mobile image, and
wherein a selection of the active region causes an additional image to be displayed over the screensaver window.

2. The system of claim 1, wherein the additional image comprises a menu of selectable options, at least one of the selectable options corresponding to an associated window displayable over the screensaver window.

3. The system of claim 2, wherein the associated window comprises an interactive window displaying an additional active region.

4. The system of claim 2, wherein selection of a one of of the selectable options causes a display of an additional menu of mobile image options, wherein a selection of a one of the mobile image options causes the first mobile image to be changed on the screensaver display.

5. The system of claim 1, wherein the screensaver window further comprises an exit option image displayed on the screensaver window.

6. The system of claim 5, wherein the exit option image comprises a second mobile image.

7. The sytem of claim 5, wherein the exit option image comprises an active region that, when activated by a user, cause the screensaver window to be cleared.

8. The system of claim 1, wherein the user device is coupled to transmit messages on a computer network, the system further comprises:
a host computer coupled to transmit messages on the computer network, the host computer having a processor for executing a host process.

9. The system of claim 8, wherein at least one of the first mobile image, active region image and additional image are based upon a module file, the module file downloadable by the host computer.

10. The system of claim 8, wherein during operation, a new module corresponding to a new selectable mobile image is downloaded from the host computer to the user device.

11. A process of displaying information on a user device, the method comprising:
displaying a screensaver window on the user device, the screensaver window having a first mobile image and an active region;
detecting a user action on the user device; and
displaying an additional image over the screensaver window.

12. The process of claim 11, wherein the additional image comprises a menu of selectable options, the method further comprising:
detecting a selection of a menu option.

13. The process of claim 12, further comprises:
displaying a new first mobile image.

14. The process of claim 12, further comprises:
displaying an associated window over the screensaver window.

15. The process of claim 11, further comprises:
displaying an exit option image on the screensaver window.

16. The process of claim 15, wherein the exit option image comprises a mobile image.

17. The process of claim 15 or 16, further comprises:
detecting an input action corresponding to the exit option; and
clearing the screensaver window.

18. The process of claim 12, wherein the user device is coupled to transmit messages on a network of computers, the process further comprising:
receiving a module from a host computer coupled to the network, the module corresponding to the additional image that may be displayed over the screensaver window.

19. The process of claim 18, wherein the received module is displayable as a new first mobile image.

20. An article comprising a machine-readable medium that stores machine-executable instructions for displaying information on a user device, the instructions causing a machine to:
display a screensaver window on the user device, the screensaver window having a first mobile image and an active region;
detect a user action on the user device; and
display an additional image over the screensaver window.

21. The article of claim 20, wherein the additional image comprises a menu of selectable options, the article further comprising instructions causing a machine to:
detect a selection of a menu option.

22. The article of claim 21, further comprising instructions causing a machine to:
display a new first mobile image.
